(19) United States
(12) Patent Application Publication
(10) Pub. No.: US 2015/0034771 A1
(43) Pub. Date: Feb. 5, 2015

(54) DEVICE FOR SUPPLYING AIR TO AN AUXILIARY POWER UNIT OF AN AIRCRAFT AND ASSOCIATED AIRCRAFT

(71) Applicant: SOCIETE DE MOTORISATIONS AERONAUTIQUES, Bourges (FR)

(72) Inventors: Hugues Denis Joubert, Paris (FR); Sebastien Ferrari, Boissise le Roi (FR)

(21) Appl. No.: 14/378,065

(22) PCT Filed: Feb. 12, 2013
(86) PCT No.: PCT/FR2013/050283

§ 371 Date: Aug. 11, 2014

(30) Foreign Application Priority Data
Feb. 13, 2012 (FR) 1251323

(51) Int. Cl. B64D 33/02; B64D 27/08; B64D 41/00; B64D 13/00

(52) U.S. Cl. CPC B64D 33/02; B64D 13/00; B64D 27/08; B64D 41/00; B64D 2041/002
USPC 244/53 B

(57) ABSTRACT

A device for supplying air to an auxiliary power unit for aircraft, including the auxiliary power unit; a turbocharger, and a cabin, the auxiliary power unit including a diesel engine coupled to the turbocharger in such a way that: the turbocharger includes a first air inlet in a compressor of the turbocharger coming from the cabin for its intake into a combustion chamber of the diesel engine, the diesel engine including: a first outlet carrying the air burnt by the combustion chamber to the turbocharger, the diesel engine delivering a power making it possible to supply an electric alternator and pressurising compressor, intended to pressurise a second air inlet, wherein the first air inlet is supplied by a fraction of pressurised air from the cabin of an aircraft.

### FIELD

The field of the invention relates to circuits for supplying air to an auxiliary power unit of an aircraft making it possible to produce electricity in an aircraft and to produce conditioned air in the cabin.

### STATE OF THE ART

Currently auxiliary power units exit, noted as APU in what follows, based either on turbine technology, or on diesel technology.

The auxiliary power units that comprise turbines have the advantage of being light and of small dimensions. This constitutes a real advantage in aeronautics. On the other hand, the output of the APUs that comprise one or several turbines is low, as the latter being of small size do not allow for the production of combustion at high pressure (of a magnitude of 10 to 15 bars) and consequently have a low thermodynamic output. In addition, in light of their small size, the technological losses are substantial, which also increases fuel consumption. By way of example, these APUs need 400 to 500 grams of kerosene in order to produce a kilowatt per hour.

However, APUs based on diesel technology have an output that is improved with regards to a turbine APU due to the fact that the combustion is carried out at a very high pressure (between 150 bars and 200 bars). With regards to the improvement in consumption, it is possible to divide the power requirements of such an APU in half. This latter solution makes it possible to decrease the fuel consumption and to recover the savings in weight of a turbine APU via the mass of the fuel saved.

The APU generally operate on the ground in order to supply conditioned air in the cabin and electricity in the aircraft when the main engines of the aircraft are stopped. The air produced is then removed from the aircraft via exhaust outlets.

Increasingly, the APU can be solicited in flight in that the main engine can: either lessen its operation; or require an additional supply in the event of a failure of a main engine occurring in the aircraft. As such, it becomes interesting to relieve the main engine by producing electricity in the aircraft and the pressurising air in part by the APU, and this even in flight. This operation can be particularly substantial, for aircraft that have a substantial number of pieces of electrical equipment (More electrical aircraft).

These increasing needs of soliciting the APU in flight have in particular a disadvantage in that the APUs used are not dimensioned to operate in flight conditions, i.e. at low temperature and at low pressure.

Typically, at an altitude of 40,000 feet, the temperature can be in the neighbourhood of values close to −55° C. and the pressure values can be around 0.20 bars. It is then not possible to start an engine of the diesel type at the surrounding temperatures and pressures.

Furthermore, another problem is that of providing operating stability of a diesel APU engine in such conditions.

There are devices for preheating the intake air used for example on land vehicles in countries where the temperatures drop to temperatures in the neighbourhood of −50° C.

But these devices do not resolve the problem of the low pressures that penalise the stability of the operation of the APU. Furthermore, they often require setting up an auxiliary burner.

Consequently, these solutions are not suited to the architecture of an aircraft that has a problem of minimum kerosene consumption.

### SUMMARY OF THE INVENTION

The invention makes it possible to overcome the aforementioned disadvantages.

The invention has for object a device for supplying air to an auxiliary power unit for aircraft, comprising:
said auxiliary power unit;
a turbocharger and;
a cabin,
said auxiliary power unit comprising a diesel engine coupled to the turbocharger in such a way that:
said turbocharger comprises at least:
one first air inlet in a compressor of the turbocharger coming from the cabin for the intake into a combustion chamber of the diesel engine,
said engine comprises at least:
one first outlet carrying the burnt air by the combustion chamber to the turbocharger.

Furthermore, the diesel engine delivers a power making it possible to supply an electric alternator and a pressurising compressor, intended to pressurise a second air inlet. The first air inlet is supplied by a fraction of pressurised air, from the cabin of an aircraft.

A single compressor is used to on the one hand be coupled to the turbine of the turbocharger and on the other hand convey into the combustion chamber of the diesel engine a fraction of pressurised air.

The turbocharger comprises a compressor that supplies the combustion chamber of the diesel engine and a turbine supplied by combustion air. This turbine drives the compressor. The electric alternator and the pressurising compressor are intended to contribute to the pressurisation of the air of the cabin of the aircraft.

The air inlet of the turbocharger is supplied by an inlet of pressurised air from the passenger or crew cabin of an aircraft. In an alternative embodiment, an operation on the ground makes it possible to supply the turbocharger via an air inlet from the outside. Advantageously, the invention makes it possible to configure this air inlet in such a way as to allow for the operation of the turbocharger on the ground or in flight with two air supply modes.

An advantage of this characteristic is that the air arriving in the diesel engine in flight is hotter and its pressure is higher than the air coming from the outside. No additional source of power is therefore used to heat the air at the inlet of the diesel engine. The latter, in these conditions, can start or be ignited without the assistance of an auxiliary burner. Furthermore, the operating stability of such an engine is improved as the air brought into the engine can be maintained at a constant temperature and at a pressure on the ground and throughout all of the phases of the flight.

Advantageously, a control valve arranged at the inlet to the auxiliary power unit makes it possible to select an air inlet entering into the combustion chamber of the engine between the first air inlet coming from the cabin of the aircraft for a configuration for use in flight and a second air inlet coming from the outside of the aircraft for a configuration for use on the ground.

An advantage is to allow for a use of the turbocharger in all phases of flight while still remaining compatible with operating modes on the ground in which the air comes from the outside.

Advantageously, an air filter is arranged at the inlet of the first air inlet.

An advantage of this characteristic is that the filter makes it possible to eliminate the parasitical particles that risk deteriorating the turbocharger and the diesel engine.

Advantageously, the pressurising compressor injects a portion of compressed air coming from the outside of the aircraft into a first mixer that mixes a fraction of air coming from the outside and a fraction of air coming from the pressurising compressor, with the first mixer delivering at the outlet a volume of pressurised air at a desired temperature and pressure. This air is conveyed into the cabin.

An advantage of this characteristic is that the auxiliary power unit can be an engine that is complementary to the main engine in all phases of the flight and on the ground. A portion of the power delivered by the main engine can therefore be produced by the auxiliary power unit, in particular with regards to the production of electrical power and the supply of the compressor making it possible to generate a volume of pressurised air in the cabin. Since the auxiliary power unit for a delivered given power consumes less kerosene than the main engine, the device of the invention makes it possible to save fuel and therefore money with regards to exterior solutions.

Advantageously, a second mixer at the outlet of the first mixer makes it possible to mix the air at the outlet of the first mixer and a fraction of air coming from the cabin. The second mixer delivers a volume of pressurised air in the cabin.

This characteristic comprises the advantage of being easily adaptable to the invention. In particular, the air outlet of the cabin intended to introduce air into the second mixer can be shared with the outlet that conveys the air of the cabin into the compressor of the auxiliary unit. A divider or a valve can be used at the outlet of the cabin in order to convey a fraction of the air into the second mixer and a fraction into the compressor C of the auxiliary power unit.

Advantageously, the invention relates to an aircraft comprising an aeration circuit comprising a device for supplying air of the invention. The advantage of such an aircraft is to consume less fuel than another aircraft.

### BRIEF DESCRIPTION OF THE DRAWINGS

Other characteristics and advantages of the invention shall appear when reading the following detailed description, in reference to the annexed figures, which show:

FIG. 1: a diagram of the main elements that make it possible to convey the air from the cabin in the auxiliary power unit;

FIG. 2: a diagram showing an architecture of the circuit for distributing air of an aircraft;

FIG. 3: a diagram showing the electrical and air distribution architecture of the auxiliary power unit with the main engine.

### DESCRIPTION

The device for supplying air of the invention makes it possible to recover a fraction of the pressurised air from the cabin in such a way as to supply the diesel engine of an auxiliary power unit. The fraction is adapted to the volume that can be taken at the inlet to the compressor C of the turbocharger.

In various alternative embodiments, a regulator makes it possible to adapt the fraction of air coming from the cabin in order to convey it to the inlet to the compressor C. The fraction of air can therefore be adapted to the size of the air inlet of the compressor C.

As the air is hotter than that of the outside and the pressure is higher than that of the outside, this supply of air makes it possible to guarantee an operation of the diesel engine of the auxiliary unit and the igniting of it on the ground and in all phases of flight. The interest of such a solution is to allow for the operation of the diesel engine in particular in flight, for the purposes of supplying the pressurised air circuit in the cabin and supplying the electrical power on board. The main advantage resides in the low consumption of the diesel engine compared to the main engine. This makes it possible to assign certain functions in flight to the diesel engine and to relieve the main engine of certain tasks.

As such an aircraft manufacturer saves fuel and benefits from a second engine in flight which makes it possible to increase operating safety when functions have to be made redundant or have a dual supply.

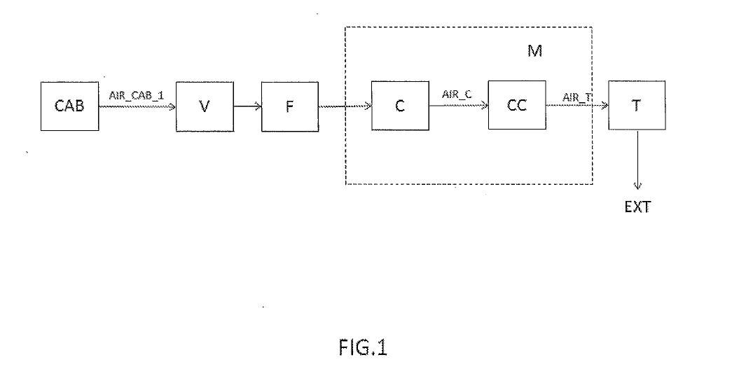

FIG. 1 shows a block diagram of the main elements that make it possible to convey the air of the device for supplying from the cabin until it is exhausted at the outlet of the diesel engine.

A cabin, noted as CAB, of the aircraft comprises pressurised air which allows passengers and the crew to obtain adequate oxygenation conditions on the ground and during the entire flight.

The cabin comprises at least one outlet noted as AIR_{—} CAB_1 intended to re-inject a fraction of air of the cabin CAB into the compressor, noted as C, of the turbojet coupled to the auxiliary power unit. The auxiliary power unit comprises a diesel engine, noted as E, which comprises a combustion chamber, noted as CC, in order to burn the incoming air noted as AIR_C coming from the compressor C and conveyed into the diesel engine.

In an alternative embodiment, a valve V can be positioned at the inlet of the auxiliary power unit in such a way as to be able to regulate the air entering into the engine E. The valve V also makes it possible to convey as input a second air inlet not shown in FIG. 1 that comes from the outside. The valve can possibly be controlled in such a way as to obtain desired pressure and temperature conditions for injecting air into the engine. The valve can be configured in such a way as to respond to a requirement in terms of the state of the aircraft from among the following states: on the ground, in flight.

The source of air that supplies the engine can therefore depend on the configuration of the aircraft if it is on the ground or if it is in flight.

An air filter F can advantageously be positioned downstream of the valve V in such a way as to filter the incoming air in particular in order to eliminate certain particles.

At the outlet of the combustion chamber CC, the burnt air AIR_T is conveyed to the turbine T of the turbocharger and is removed to the exterior EXT of the aircraft. The turbine T makes it possible to drive the compressor C of the turbocharger.

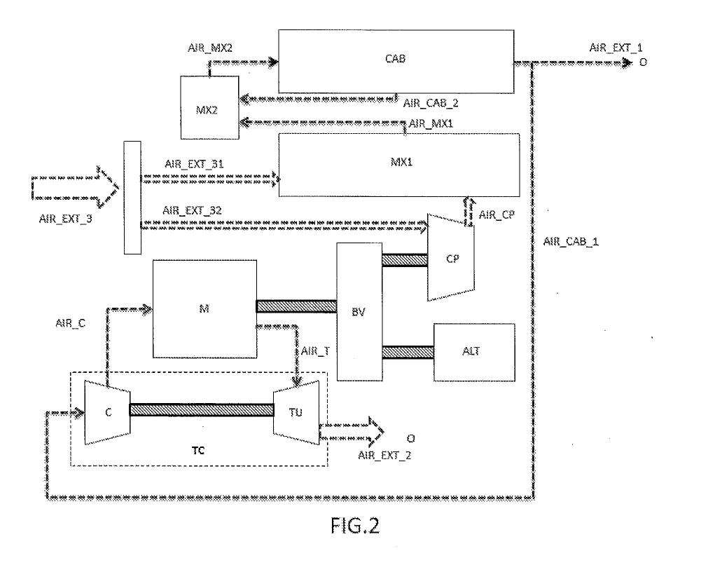

FIG. 2 shows a detailed example of an embodiment of the device for supplying air of the invention.

The arrows as a dotted line show the air flows. A fraction AIR_CAB_1 of the air of the cabin CAB is taken in order to be conveyed to the compressor C coupled to the APU as already stated in FIG. 1. The diesel engine E takes the compressed air AIR_C coming from the compressor C of the turbomachine TC. The burnt air AIR_T is re-injected into the turbine TU which removes the air AIR_EXT_2 to the outside. The outside is noted as O in FIG. 2.

The diesel engine E makes it possible to drive a gearbox GB, with the latter delivering a first power to an alternator ALT and a second power to a pressurising compressor CP. The deliveries of power are transmitted mechanically.

The alternator ALT makes it possible to create and supply electrical power to the aircraft.

The pressurising compressor CP is driven by the gearbox GB and compresses a volume of air AIR_EXT_32 coming from a fraction of an air inlet from the exterior noted as AIR EXT 3 and entering the compressor CP. The air compressed as such AIR_CP is injected into a first mixer, noted as MX1. The compressed air AIR_CP therefore arrives in the mixer MX1 at a desired temperature and pressure, in particular higher than the pressure and the temperature than the volume of air AIR_EXT_32.

A second fraction of the air AIR_EXT_31 of the outside air AIR_EXT _3 entering into the aircraft is conveyed directly into the first mixer MX1 without being introduced into the pressurising compressor CP.

The first mixer MX1 makes it possible to mix the two volumes of incoming air: on the one hand a first volume AIR_CP coming from the pressurising compressor CP and on the other hand a second volume AIR_EXT_31 coming from the outside of the aircraft. The volume of air AIR_EXT_31 is at a pressure and a temperature that is lower than the volume of air AIR_CP in the first mixer MX1. The air mixed in the first mixer AIR_MX1 is conveyed to a second mixer MX2. The function of the mixer MX1 is to homogenise the pressure of the two incoming volumes of air AIR_CP and AIR_EXT_31.

The second mixer MX2 located downstream of the first mixer MX1 makes it possible to deliver a volume of mixed air AIR_MX2 in the cabin CAB of an aircraft. A fraction of the air of the cabin AIR_CAB_2 is taken in the cabin in order to be mixed with the volume of air AIR_MIX_1 coming into the second mixer MX2 and coming from the first mixer MX1. The function of the second mixer is to homogenise the temperature of the mixed air before introducing it into the cabin CAB.

The air of the cabin CAB is therefore:
taken, for a first fraction, in such a way as to be conveyed to the second mixer MX2 via the outlet AIR_CAB_2,
exhausted, for a second fraction, to the outside O via an outlet AIR_EXT_1 and;
taken, for a third fraction, via the outlet AIR_CAB_1 in order to be injected into the compressor C of the turbocharger TC of the auxiliary power unit APU.

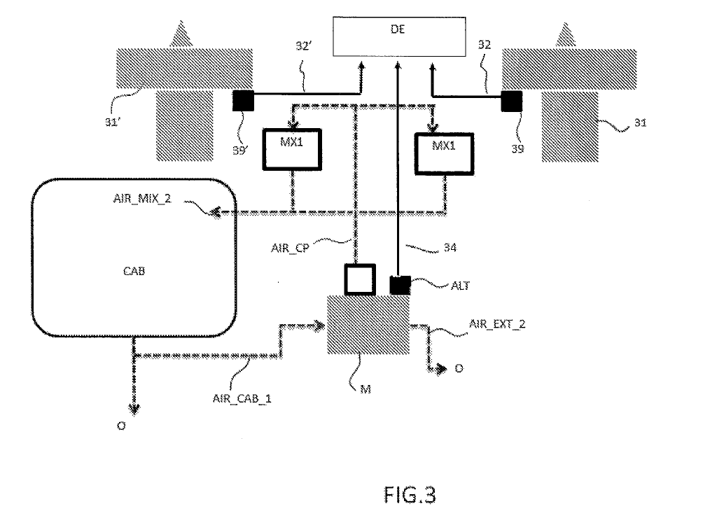

FIG. 3 makes it possible to show the device for supplying in the aircraft with the main engines 31, 31′ which make it possible to deliver a portion of their power to alternators 39, 39′. The alternators 39, 39′ supply electricity to electrical distribution equipment DE by means of electrical inputs 32, 32′. It is understood in FIG. 3 that the diesel engine E makes it possible to generate an electrical power by means of a dedicated alternator ALT which can potentially supply the electrical distribution network of the aircraft in flight by the intermediary of an inlet 34.

An interest of this solution is that the production of electricity by the alternator ALT is more economical than that produced with the alternators 39, 39′, given that the engine E consumes less than the main engines of the aircraft.

The second mixer is not shown in FIG. 3. It can be removed in an alternative embodiment.

The invention therefore makes it possible to have for an auxiliary power unit in an aircraft a diesel engine that is more economical and which consumes less kerosene than a turbine technology engine for example. An advantage is that such an engine can then be used during the phases of flight as the air required at the inlet to the engine can be maintained in optimum pressure and temperature conditions for its start-up and its operation and guarantee stability all throughout its operation.

1. A device for supplying air to an auxiliary power unit for aircraft, comprising:
said auxiliary power unit;
a turbocharger and;
a cabin,
said auxiliary power unit comprising a diesel engine coupled to the turbocharger in such a way that:
said turbocharger comprises:
a first air inlet in a compressor of the turbocharger coining from the cabin for its intake into a combustion chamber of the diesel engine,
said diesel engine comprising:
a first outlet carrying the air burnt by the combustion chamber to the turbocharger,
the diesel engine delivering a power making it possible to supply an electric alternator and pressurising compressor, intended to pressurise a second air inlet wherein the first air inlet is supplied by a fraction of pressurised air from the cabin of an aircraft.

2. The device for supplying air according to claim 1, comprising a control valve arranged at an inlet of the auxiliary power unit makes it possible to select an air inlet entering into the combustion chamber of the engine between the first air inlet coming from the cabin of the aircraft for a configuration of use in flight and a second air inlet coming from the outside of the aircraft for a configuration of use on the ground.

3. The device for supplying air according to claim 1, comprising an air filter is arranged at the inlet of the first air inlet.

4. The device for supplying air according to claims 1, wherein the pressurising compressor is constructed and arranged to inject a portion of compressed air coming from the outside of the aircraft into a first mixer which mixes a fraction of air coming from the outside and a fraction of air coming from the pressurising compressor, with the first mixer delivering as output air for the cabin.

5. The device for supplying air according to claim 1, comprising a second mixer at the outlet of the first mixer makes it possible to mix the air at the outlet of the first mixer and a fraction of air coming from the cabin, with the second mixer delivering a volume of pressurised air in the cabin.

6. An aircraft comprising a circuit for aerating the air comprising a device for supplying according to claim 1.
